(19) United States
(12) Patent Application Publication
(10) Pub. No.: US 2010/0248573 A1
(43) Pub. Date: Sep. 30, 2010

(54) FLEXIBLE 3-D TEXTILE STRUCTURE AND METHOD OF PRODUCING THEREOF

(76) Inventor: Pinhas Hascalovich, Haifa (IL)

Correspondence Address: Pearl Cohen Zedek Latzer, LLP, 1500 Broadway, 12th Floor, New York, NY, 10036, US

(21) Appl. No.: 12/663,951

(22) PCT Filed: Jun. 11, 2008
(86) PCT No.: PCT/IL08/00793

§ 371 Date: May 25, 2010

Related U.S. Application Data
(60) Provisional application No. 60/929,047, filed on Jun. 11, 2007.

(51) Int. Cl. B32B 3/26; D03D 13/00; D04B 1/00; B32B 27/12

(52) U.S. Cl. 442/205; 428/304.4; 442/312

(57) ABSTRACT

A three-dimensional structure is disclosed comprising a three-dimensional fabric with spaces within filled with flexible foam.

### FIELD OF THE INVENTION

The present invention relates to a three-dimensional textile structures. More specifically the present invention relates to a flexible three-dimensional textile structure and method of producing thereof.

### BACKGROUND OF THE INVENTION

Various technologies for the production of high-strength, relatively light weight, fabric-core sandwich structures where a resin connects two skins, have been publicized. The rigid resin restricts the possibility to obtain a complex spatial shape structures.

Examples of such technologies are:

U.S. Pat. No. 7,048,985 (Mark et al.) “Three-dimensional spacer fabric resin infusion media and reinforcing composite lamina”: A three-dimensional spacer fabric resin infusion medium and reinforcing composite lamina for use in the manufacture of fiber reinforced polymer composites is disclosed. The use of the three-dimensional spacer fabric as a composite lamina aids in both the resin infusion rate and resin uniformity throughout the laminate.

U.S. Pat. No. 7,060,156 (Mark et al.) “Three-dimensional spacer fabric resin interlaminar infusion media process and vacuum-induced reinforcing composite laminate structures.” A three-dimensional spacer fabric resin interlaminar infusion medium and reinforcing composite lamina for use in the vacuum-induced manufacture of fiber reinforced polymer composites is described. This use of the three-dimensional spacer fabric as a composite interlaminar component improves both the vacuum-induced resin infusion flow rate and laminate quality control and aids in the achievement of enhanced resin uniformity distribution throughout the laminate.

Another technology is a textile core sandwich structure disclosed in WO 2006/033101 (Haskalovich and Tokarsky). This technology relates to a 3D knitted textile core, placed between two skins to obtain a sandwich structure with low weight and high strength. The 3D shaped skins are produced apart, and the flexible core is placed in the mold between the skins for adhesion/welding. Although the skins can be made using various processes, including vacuum infusion and resin-transfer-molding (RTM), the sandwich structure however obtains no advantage in using this process since the resin fills all the cavities in the textile core, thus canceling the weight advantages of the light sandwich core.

Parabeam b.v. (Helmond, The Netherlands) produces a single step sandwich structure from a 3D glass fiber weaved fabric. The fabric is immersed in resin (preferably polyester) to obtain a light sandwich structure. While the structure of the 3D glass fiber sandwich allows for some flexibility in the making of complex spatial shape structures, their strength, particularly the compression and bending-resistance it limited, thus the shapes that can be obtained are restricted to having small curvatures and angles.

The term “honeycomb” typically refers to a mass of hexagonal cells of a structure similar to that produced by bees for the storing of honey. In the context of textile fabric sandwich-cores from here after the term “honeycomb” refers to a densely proliferated textile fabric sheet with the cells or holes, typically but not necessarily, of hexagonal configuration, and typically but not necessarily, adjacent to each other. The term fabric refers from here after in the text to a woven 3-dimensional fabric as well as to a knitted 3-dimensional fabric.

Sandwich structures with honeycomb cores are typically very efficient in their strength to weight ratio characteristics. This is the main reason of their frequent use in aerospace market, where low weight and high strength are major factors for achieving mechanical requirements.

Honeycomb sandwiches—sandwiched structure incorporating two substantially opposite skins with honeycomb core in between—share a major limitation:

The production of honeycomb sandwiches requires manufacturing the honeycomb core from metal (usually aluminum), plastic injection, sheet folding or resin infusion of paper honeycomb and connecting with various methods two skins on either side. They can be made in flat plates but difficult to manufacture in 3D complex shapes in space. Thus the main application for these plates is floors and partitions, or any other flat part. Additional processing like machining, cutting, adhering the core and the skins, and/or assembling various flat parts is required in order to obtain a complex part, therefore the end part is relatively expensive, and requires additional frame for assembly.

Embodiments of the present invention disclose a method for producing honeycomb 3-dimensional foam-loaded textile fabrics that enable the production of spatial sandwich constructions.

### SUMMARY OF THE INVENTION

There is thus provided, in accordance with some embodiments of the present invention, a three-dimensional structure comprising a three-dimensional fabric with spaces within filled with flexible foam.

Furthermore, in accordance with some embodiments of the present invention, the three-dimensional fabric comprises three-dimensional woven fabric.

Furthermore, in accordance with some embodiments of the present invention, the three-dimensional fabric comprises three-dimensional knitted fabric.

Furthermore, in accordance with some embodiments of the present invention, the flexible foam comprises foamed material selected from a group of foamed materials including: polyurethane, PVC-foam and acrylic-foam.

Furthermore, in accordance with some embodiments of the present invention, the structure is provided as a core in a sandwich structure comprising two substantially opposite surfaces.

Furthermore, in accordance with some embodiments of the present invention, the substantially opposite surfaces comprise fabric surfaces.

Furthermore, in accordance with some embodiments of the present invention, the fabric surfaces comprise materials selected from a group of fabric materials including: fiberglass, Kevlar, carbon and basalt.

Furthermore, in accordance with some embodiments of the present invention, the opposite surfaces are connected by fibers.

Furthermore, in accordance with some embodiments of the present invention, the fibers are made from one or more materials selected from a group of fiber material including: Polyamide, Polyester, Polyurethane, Polyvinyl, Acryl, Polyethylene, Polypropylene, Polycarbonate, PEEK and Polystyrene.

Furthermore, in accordance with some embodiments of the present invention, the structure further comprises a resin injected into spaces between the fibers.

Furthermore, in accordance with some embodiments of the present invention, the resin comprises materials selected from a group of resin materials including: epoxy, polyester and phenol.

Furthermore, in accordance with some embodiments of the present invention, the structure is molded in a desired shape using a resin transfer molding device.

Furthermore, in accordance with some embodiments of the present invention, the structure is molded in a desired shape using a vacuum bag device.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is a cross cut side view illustration of a three-dimensional fabric core according to embodiments of the present invention, with the cells of the fabric about to be filled by foam by “punch-through” pistons.

FIG. 2A is a side view illustration of a three dimensional fabric according to embodiments of the present invention, with wax coated fibers.

FIG. 2B is a side view illustration of the fabric illustrated in FIG. 2A closed in a mold with the cells of the core filled with foam.

FIG. 3 is an isometric illustration of the fabric illustrated in FIG. 1 and in FIG. 2A, with the cells of the fabric filled with foam.

FIG. 4 is a cross cut side-view of a fabric being covered with reinforcing fabrics and molded into shape in a vacuum-ban mold, according to embodiments of the present invention.

FIG. 5 is a cross cut side-view of a fabric being coated with reinforcing fabrics and molded into shape in a resin-transfer-mold (RTM) device according to embodiments of the present invention.

### DETAILED DESCRIPTION OF EMBODIMENTS OF THE INVETION

Embodiments of the present invention present a method for creating a spatial high endurance yet flexible structure that includes foam-filled or foam-loaded (the two terms used interchangeably) three-dimensional (e.g. honeycomb configuration) textile fabrics that are fixed after molding in a desired shape. The flexible-foam for the filling of the spaces (e.g. honeycomb-spaces) in the fabric can be made from, for example, polyurethane, PVC-foam and acrylic-foam. The term “fabric” in the context of the present invention refers to a woven or knitted three-dimensional fabric. The fabric can be produced from fibers made of polymeric compounds such as, for example, polyamide, polyester, polyurethane, polyvinyl, acryl, polyethylene, polypropylene, polycarbonate, PEEK and polystyrene. The fibers run in a three-dimensional manner from one face of the structure to an opposite face. The woven or knitted fabrics can be manufactured by industrial textile machines.

A honeycomb structure is described in the present specification, but it is understood that other three-dimensional (3-D) structural configurations may also be used. For brevity throughout the present specification the term “honeycomb” is used. Using flexible foam-loaded honeycomb textile fabrics as cores facilitates the production of sandwich-structures in a single step using one mold, in a common and widely spread process, e.g. vacuum infusion or resin-transfer-molding (RTM), a textile 3-D fabrics in the shape of honeycomb is manufactured, to be used as a core. Known reinforcing fabrics (such as, for example, fiberglass, Kevlar, carbon and basalt) are used as skins to form a sandwich structure, bonded to the core on either opposite sides using known matrix resins (such as, for example, epoxy, polyester and phenol). The fibers of the fabrics bridge between the two substantially opposite reinforcing skins. The mechanical characteristics of a foam-filled honeycomb sandwich depend on the structural materials used as well as on the mold and the process equipment utilized.

The technology in accordance with embodiments of the present invention enables the production of optimized sandwich structures: The strength of the structure can be designed to be enhanced and oriented in a predetermined direction in one of the X; Y planes, Z plane and a combination therein. The thickness of the honeycomb structure, the size of the cells and their shape is designed in such a manner so as to predetermine a strength-to-weigh ratio of the structure. Variable shapes and curvatures, and various thicknesses of the core may be achieved. The external finish may be dictated by the surface of the mold. The honeycomb structure is reinforced by the fibers extending in various directions—lateral and tangential—thus the sandwich properties are enhanced (to withstand shear, delimination and compression forces). The manufacturing technology according to embodiments of the present invention may range from home made or small size production to automated large scale production.

Some possible applications of embodiments of the present invention may include aerospace parts, marine parts (boat and yacht hulls), automotive and transportation bodies and parts, and construction architectural components.

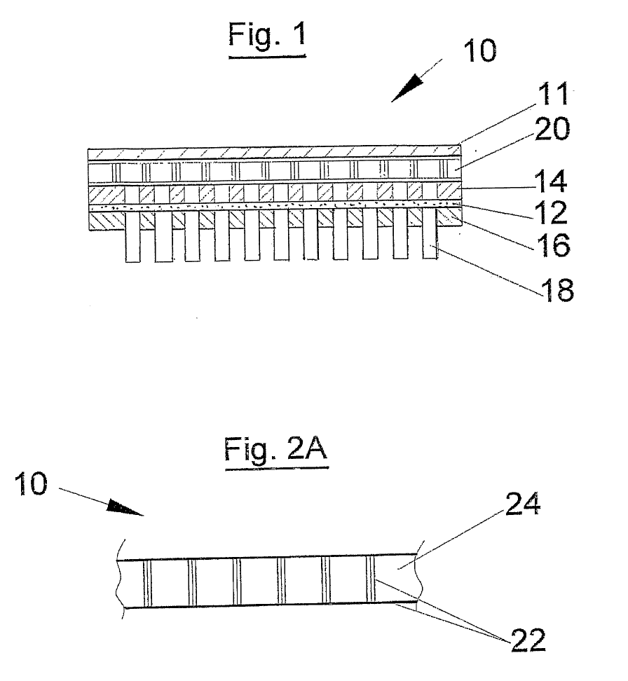

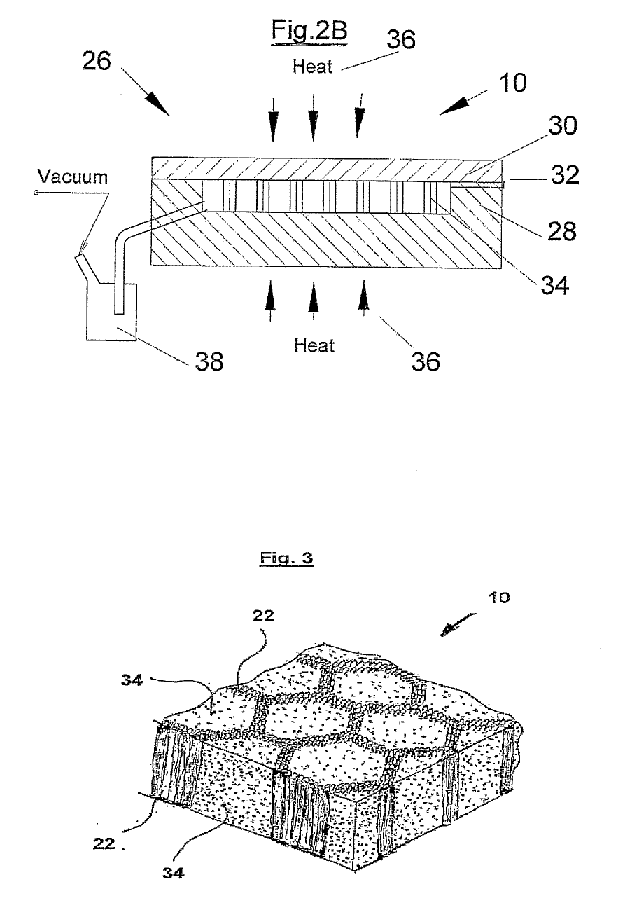

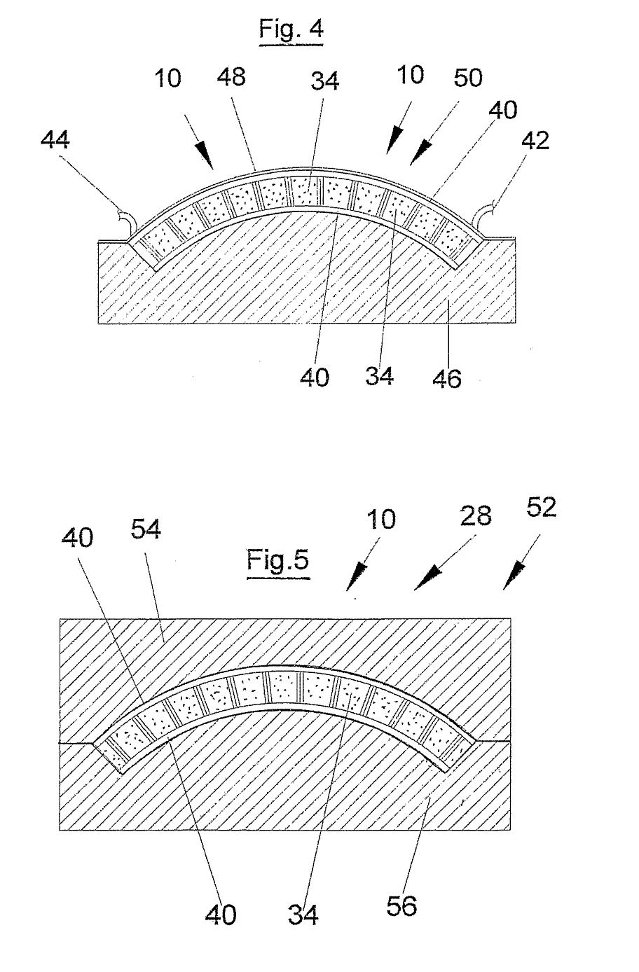

The production of a spatial textile fabric core sandwich in accordance with some embodiments of the present invention is based on a core made of foam-loaded honeycomb textile fabrics. The honeycomb-cells (referred to also as “spaces”) of the core are confined by fibers running substantially perpendicularly between opposite sides of the core. Two techniques of filling the cells of with flexible foam, such as polyurethane, without damaging the proliferated structure of the core are disclosed herein: the first is illustrated in FIG. 1, the second in FIG. 2A and FIG. 2B. A foam filled honeycomb fabric is illustrated in FIG. 3. The foam filled fabric may be used as a core in a sandwich structure, and for that aim it is covered on both sides by “skin” reinforcing fabrics layers. The flexible sandwich is then molded into a desired shape. In the next stage, the sandwich is fixed in the desired shape by infusing a fixing resin, such as epoxy, between the voids and spaces of the fibers of the textile core material and between the core and the skin fabric layers. The molding and introduction of the resin is done by either vacuum-bag-technique or a RTM-technique, as illustrated in FIG. 4 and FIG. 5, respectively.

Reference is now made to two embodiments in accordance with embodiments of the present invention disclosing alternative techniques of filling the spaces of a honeycomb textile fabric with foam: “punch-filling” or “vacuum filling” while keeping the fibers of the honeycomb fabric free from foam and wax coating.

FIG. 1 is an illustration of filling with foam a honeycomb textile fabric 10 utilizing the “punch-filling” technique. A sheet of flexible low density closed cell foam 12 is placed and pressed between two metal perforated plates, 14 and 16. The size and shape of the perforations match the shape of the relevant textile core. A plurality of matching punch-through pistons 18 is aligned with the holes of the perforated metal plates. A 3D textile fabric with matching open cells 20 is aligned on top of the perforated metal plate. The punch-through pistons are mechanically, hydraulically or pneumatically operated to punch and push the foam sheet into the textile fabric, such that the open cells of the textile fabric are filled with foam. A hard-material top layer counter-plate 11 is used to stabilize the sheets of the textile fabric, metallic plates and foam in the process of “punch-filling”

FIG. 2A and FIG. 2B are illustrations of filling with foam a honeycomb textile fabric 10 utilizing the “vacuum filling” technique.

FIG. 2A is an illustration of a 3D textile fabric 10 coated with wax. The coating is done by wax-immersion or wax casting into a mold. When the wax is cooled the fibers 22 of the textile fabric (running between the two faces as well as along the faces) are coated with wax while leaving the open cells 24 free of wax.

FIG. 2B is an illustration of the wax fiber-coated 3D fabric 10 shown in FIG. 2A placed into molding device 26. Molding device 26 has a container-body 28 and a lid 30, connected by a locking mechanism 32. Low density flexible foam, such as, for example, polyurethane, is injected into the mold so that the foam fills all the open cells of the fabric 34. The foam-filled textile fabric 10 is conveyed while still in molding device 26 though a hot air oven 36. The heat melts the wax coating on the fibers of textile fabric 10 (22 in FIG. 2A) and, with the aid of a vacuum draining system 38, the wax is removed.

FIG. 3 is an isomeric illustration of textile fabric 10 after the “punching-in” of foam, as illustrated in FIG. 1, or after the removal of the wax from fabric 10, as illustrated in FIG. 2B. Foam 34 is shown filling the cells of the fabric (numbered 24 in FIG. 2A) and the fibers 22 of fabric 10 are shown free of foam and of wax.

After producing a flexible honeycomb 3D textile fabric loaded with foam without having foam or wax in or on the fibers that define the spaces of the honeycomb (with either the “punch-filling” or the “vacuum filling” techniques, as explained above) the fabric is used as a core in a sandwich-structure. The fabric is covered by “skins” of reinforcing fabrics on both its sides and the sandwich-structure is now molded into a desired shape utilizing either a vacuum-bag-mold device 50 (FIG. 4) or a resin-transfer-molding (RTM) device 52 (FIG. 5). When the desired shape is obtained resin is infused or injected into the sandwich. The resin fills spaces between the fibers and the spaces between the reinforcing fabrics and the core—thus fixing the “skins” in position in a desired shape. The application of the skins onto the core and fixing of the honeycomb core in the desired shape are done concurrently.

FIG. 4 is a cross cut side-view of a 3D textile fabric 10, in accordance with an embodiment of the present invention, being molded into a desired shape and covered with reinforcing fabrics 40 in a vacuum-bag device 50. Vacuum bag device 50 is constructed of a main-body structure 46 and cover 48 that creates an enclosed volume that fits the contours of the treated sandwich structure. In operating vacuum-bag, air removed from the enclosed volume through tube 42 and through tube 44 a resin is inserted into fabric 10 positioned between main-body structure 46 and a cover 48. The resin completely fills the voids and spaces between the fibers and the space between the core and the skins in fabric 10 and is left to harden and fix rigidly.

FIG. 5 is a cross cut side-view of a 3D textile fabric 10, in accordance with an embodiment of the present invention, being molded into a desired shape and covered with reinforcing fabrics 40 in a in a resin-transfer-molding (RTM) device 52. RTM device 52 molds fabric 10 between its upper and lower components, 54 and 56 respectively. After molding, to foam 34 in fabric 10 resin in injected by the RTM device. The resin completely fills the voids and spaces between the fibers and the space between the core and the skins in fabric 10 and is left to harden and fix rigidly.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A three-dimensional structure comprising:
a three-dimensional fabric with spaces within filled with flexible foam.

2. The structure as claimed in claim 1, wherein the three-dimensional fabric comprises three-dimensional woven fabric.

3. The structure as claimed in claim 1, wherein the three-dimensional fabric comprises three-dimensional knitted fabric.

4. The structure as claimed in claim 1, wherein the flexible foam comprises foamed material selected from a group of foamed materials including: polyurethane, PVC-foam and acrylic-foam.

5. The structure as claimed in claim 1, provided as a core in a sandwich structure comprising two substantially opposite surfaces.

6. The structure as claimed in claim 5, wherein the substantially opposite surfaces comprise fabric surfaces.

7. The structure as claimed in claim 6, wherein the fabric surfaces comprise materials selected from a group of fabric materials including: fiberglass, Kevlar, carbon and basalt.

8. The structure as claimed in claim in claim 5, wherein the opposite surfaces are connected by fibers.

9. The structure as claimed in claim 8, wherein the fibers are made from one or more materials selected from a group of fiber material including: Polyamide, Polyester, Polyurethane, Polyvinyl, Acryl, Polyethylene, Polypropylene, Polycarbonate, PEEK and Polystyrene.

10. The structure as claimed in claim 8 further comprising a resin injected into spaces between the fibers.

11. The structure as claimed in claim 10, wherein the resin comprises materials selected from a group of resin materials including: epoxy, polyester and phenol.

12. The structure as claimed in claim 5 molded in a desired shape using a resin transfer molding device.

13. The structure as claimed in claim 5 molded in a desired shape using a vacuum bag device.
